(19) United States
(12) Patent Application Publication
(10) Pub. No.: US 2015/0122015 A1
(43) Pub. Date: May 7, 2015

(54) CAPACITIVE LEVEL SENSOR

(71) Applicant: KONINKLIJKE PHILIPS N.V., EINDHOVEN (NL)

(72) Inventor: Michael James Robbert Leppard, Hunston (GB)

(73) Assignee: KONINKLIJKE PHILIPS N.V., EINDHOVEN (NL)

(21) Appl. No.: 14/403,688

(22) PCT Filed: Jun. 10, 2013
(86) PCT No.: PCT/IB2013/054742

§ 371 Date: Nov. 25, 2014

Related U.S. Application Data
(60) Provisional application No. 61/659,470, filed on Jun. 14, 2012.

(51) Int. Cl. G01F 23/26

(52) U.S. Cl. CPC G01F 23/266
USPC 73/304 C

(57) ABSTRACT

A capacitive liquid level sensor in which a vessel for receiving the liquid has a deflector inside the vessel extending upwardly from the base, and which tapers towards its top. This means the liquid is confined to the edges of the vessel at the bottom of the vessel, which gives improved resolution for small amounts of liquid. The deflector also acts as a baffle resisting liquid flow when there is tilting of the vessel.

### TECHNICAL FIELD OF THE INVENTION

This invention relates to a capacitive liquid level sensor.

### BACKGROUND OF THE INVENTION

There are many examples of capacitive liquid level sensors on the market, which use capacitance to detect liquid levels.

A known type of liquid level sensor comprises a cylinder which is to be filled (or part filled) with the liquid to be sensed. Capacitor plate electrodes extend up the outside of the cylinder wall in the form of elongate strips. There is a series of electrodes around the cylinder, which together define a pair of capacitor plates. The capacitance depends on the fluid level in the cylinder, since the liquid influences the dielectric permittivity between the electrodes. The level of the liquid determines the capacitor area over which this permittivity is effective.

This standard capacitive liquid level sensor has two principal disadvantages. The sensor is sensitive to operating angle and in practice it has a limited dynamic range.

### SUMMARY OF THE INVENTION

According to the invention, there is provided a level sensor as claimed in claim 1.

The invention provides a liquid level sensor comprising:
a vessel for receiving the liquid having a base;
a capacitor arrangement for detecting the liquid level in the vessel based on the permittivity of the liquid and the height of the liquid in the vessel; and
a deflector inside the vessel extending upwardly from the base, having a greatest area, in a plane perpendicular to the vessel height, at the base and decreasing in area towards the top of the deflector.

This sensor design has a deflector within the container. It is preferably centrally positioned with respect to the vessel. The result is that the level of filling of the vessel is a non-linear function of the volume of liquid. This enables the sensor to be able detect small liquid levels and it also enables it to be more tolerant to changes in the operating angle.

The deflector can have a conical or frusto-conical outer shape.

The base area of the deflector is preferably at least half the base area of the vessel. In this way, small changes in liquid volume when the vessel is near empty cause larger changes in liquid level which can thus be detected.

The deflector preferably extends at least half way up the vessel. Thus, the deflector is used at least for relatively low liquid volumes. It can however, extend all the way up the vessel.

The area at the top of the deflector is no more than half the base area of the deflector so that a significant taper is provided.

The capacitor arrangement can comprise a series of parallel capacitor electrodes around the vessel each extending in the direction of the vessel height, with sets of electrodes connected together such that there are two capacitor terminals. The series of parallel capacitor electrodes can be copper tracks provided on a flexible printed circuit board which is wrapped around the vessel.

A second vessel can be provided in fluid communication with the vessel, for detecting a permittivity of the liquid. This for example enables a drug type to be detected, by measuring the relative permittivity of a fixed volume of drug. All drugs have a definable permittivity, and once this has been measured a lookup table can be used to determine the drug filled within the second vessel.

The second vessel can comprise a cylinder located beneath the vessel. The second vessel will thus fill first and a single filling opening is at the top of the sensor. A capacitor electrode arrangement can also be provided around the second vessel.

By way of example, the vessel can comprise a cylinder with an internal diameter in the range 10 mm to 20 mm and a height in the range 10 mm to 40 mm, and the deflector can comprise a cone with base diameter in the range 75% to 100% of the internal cylinder diameter, or a frusto-cone with base diameter in the range 75% to 100% of the internal cylinder diameter and a top diameter in the range 30% to 60% of the internal cylinder diameter. The second vessel cylinder can have an internal diameter in the range 1 mm to 5 mm.

### BRIEF DESCRIPTION OF THE DRAWINGS

An example of the invention will now be described in detail with reference to the accompanying drawings, in which:

FIG. 1 shows the vessel of a capacitive fluid sensor of the invention; and

FIG. 2 shows an example of how to implement the electrode array.

### DETAILED DESCRIPTION OF THE EMBODIMENTS

The invention provides a capacitive liquid level sensor in which a vessel for receiving the liquid has a deflector inside the vessel extending upwardly from the base, and which tapers towards its top. This means the liquid is confined to the edges of the vessel at the bottom of the vessel, which gives improved resolution for small amounts of liquid. The deflector also acts as a baffle resisting liquid flow when there is tilting of the vessel.

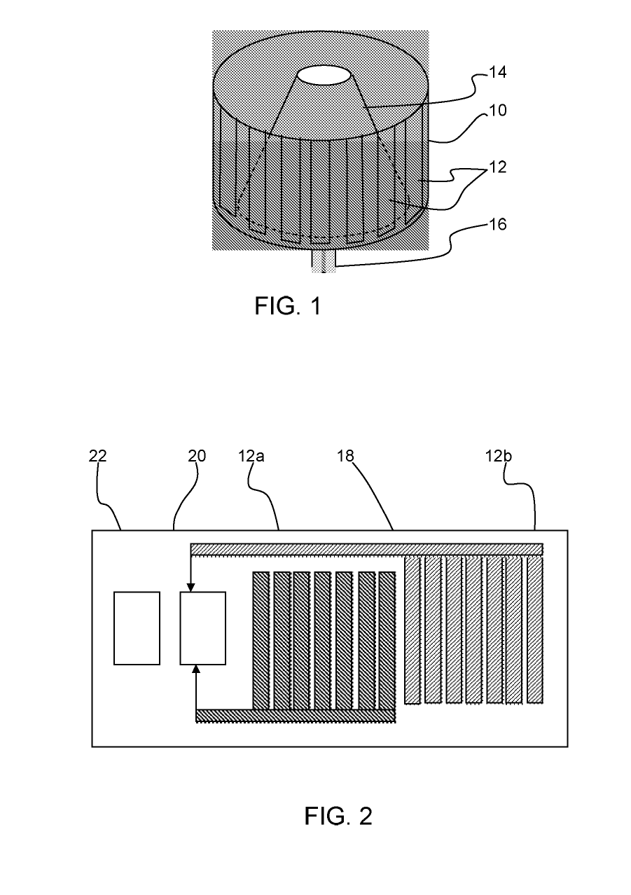

FIG. 1 shows the vessel of a capacitive fluid sensor of the invention. The capacitive liquid level sensor comprises a container 10 with an even number of surrounding metal electrodes 12 which are elongate and arranged vertically. The electrodes define two opposing capacitor plates. They are segmented into vertical strips to make it possible to bend a PCB carrying the electrodes around the vessel.

The liquid within the container has a dielectric constant, and the capacitance is proportional to the dielectric constant and hence generally proportional to the liquid level.

The capacitance can be measured with a capacitor measurement chip, for example providing a serial output.

The electric field lines from the electrodes run perpendicularly to the electrodes (i.e. radially across the vessel) and the electric field is strongest nearest the electrodes. The electric field strength also means that the liquid closest to the electrodes has most influence on the capacitance.

If the vessel is tilted, the capacitance will change due to the different (and complex) interaction between the electrodes and the liquid. A conventional capacitive liquid level sensor will be subject to an error resulting from its operating angle which is approximately proportional to the amount of liquid it contains. If the vessel is full of liquid, then it can be moved over any angle and the amount of liquid contained within the sensing capacitor plates will remain the same so there is no error.

However, if the vessel is half full of liquid then for example at an angle of 45° (between capacitor plates on diametrically opposite sides of the vessel), one capacitor plate will be in contact with significantly less liquid than the other. Although the liquid will be higher up one electrode than previously, the capacitance will decrease because the area between the electrodes fully filled with the liquid dielectric will have decreased. With the capacitance proportional to the area of the liquid (fully) between the plates, the capacitance will be less, hence giving rise to an error.

The vessel of the invention has a deflector 14 inside the vessel extending upwardly from the base. The deflector tapers in its upward direction, so that it has a larger area (in the cross section perpendicular to the vessel height) at the base and decreasing in area towards the top of the deflector. This means that lower in the vessel, the liquid is forced to reside close to the outer wall and therefore closer to the electrodes.

In this way, a small increase in the amount of liquid contributes to a large increase in liquid level, giving an increased dynamic range. In particular, the sensitivity is proportional to the amount of liquid contained. When the container is empty a small increase in liquid gives a large increase in liquid seen by the capacitor plates. When the container is almost full a small increase in liquid gives a small increase in liquid seen by the capacitor plates.

The error which arises from titling is reduced by the addition of the inner deflector. The deflector acts as a baffle, reducing movement of liquid when there is titling, as a result of the surface tension of the container and deflector walls. This reduces the effect of the angle on the sensor output. The deflector also forces the liquid near the electrodes with the effect that the tilting error is reduced.

In the example shown, the deflector has a conical or frusto-conical outer shape. This means the outer envelope of the deflector (in a vertical plane) is straight. However, this is not necessary, and the deflector can reduce in surface area in a non-linear way. The base area of the deflector can correspond to the base of the vessel, or it can only partially cover the base of the vessel, as shown in FIG. 1. The area at the bottom of the deflector is preferably at least half the base area of the vessel to provide the increased sensitivity.

The deflector can extend all the way up the vessel as shown in FIG. 1, but it can extend only partially up the vessel volume, for example at least half way up. The deflector can be conical (i.e. tapering to a point at the top) or truncated (frusto) conical. In the case of a truncated cone, the taper is such that the area at the top of the deflector is no more than half the base area of the deflector.

FIG. 1 also shows a secondary vessel 16. This is in fluid communication with the main vessel, and holds a small amount of liquid. It fills first and is thus beneath the level sensing vessel. This secondary vessel is used to establish (in known manner) the drug type filled within the chamber by measuring its permittivity. This permittivity can then be used to address a lookup table of drug permittivity values.

The sensor of FIG. 1 thus essentially comprises two cylindrical vessels. By way of example, the main vessel is typically 20 mm high by 15 mm internal diameter. Within this vessel is the cone-shaped deflector, typically 13 mm diameter at the bottom by 6 mm diameter at the top. Around the outer edge of the cylinder is the series of capacitor plates.

The second cylinder is typically 10 mm high by 3 mm diameter. Again, around the outer edge of this second vessel cylinder is a series of capacitor plates.

The two capacitor plate arrangements can each be formed by wrapping a flexible PCB around the respective cylinder, with the capacitor electrode plates made from copper PCB tracks.

FIG. 2 shows one such flexible PCB arrangement 18. The capacitor electrodes 12 are shown as two groups 12a, 12b defining two capacitor plates, and they connect to a capacitance measurement circuit 20. The PCB carries other circuitry components shown schematically as 22. Each capacitor electrode extends in the direction of the vessel height, with two sets of electrodes connected together such that there are two capacitor terminals.

An example of specific typical dimensions has been given above. More generally, the main vessel cylinder can have an internal diameter in the range 10 mm to 20 mm and a height in the range 10 mm to 40 mm, and the deflector can comprise a cone with base diameter in the range 75% to 100% of the internal cylinder diameter, or a frusto-cone with base diameter in the range 75% to 100% of the internal cylinder diameter and a top diameter less than 60% of the internal cylinder diameter, or more preferably in the range 30% to 60% of the internal cylinder diameter.

In the example above, the vessel is circular cylindrical and the deflector is conical. However, the vessel can be any shape, for example a polygonal cylinder. The deflector can then be a pyramid (or truncated pyramid) with a base having the same polygon shape as the vessel shape.

The example above has two vessels. The invention can be implemented with only the main vessel, for example if analysis of the liquid is not required, and only a level sensing function is needed.

Only one example of capacitance arrangement has been shown, with electrodes all around the vessel. However, there may be other arrangements. For example there may be just two electrode lines diametrically opposite each other. There may be four electrodes spaced at 90 degrees around the vessel. This can define two capacitors, which can be measured in serial manner. Thus, instead of having two fixed capacitor terminals and a single capacitance measurement, a separate capacitance measurement can be made for two or more pairs of opposing electrodes in a sequence. Thus, various capacitor terminal arrangements are possible.

The invention can be used in any liquid detecting, level sensing or liquid administering device.

In the description and claims, the sensor is described as having a deflector inside a vessel. Of course, they may be fabricated as a single moulded component.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

1. A liquid level sensor comprising:
a vessel for receiving the liquid having a base;
a capacitor arrangement for detecting the liquid level in the vessel based on the permittivity of the liquid and the height of the liquid in the vessel; and
a deflector inside the vessel extending upwardly from the base, having a greatest area, in a plane perpendicular to the vessel height, at the base and decreasing in area towards the top of the deflector.

2. A sensor as claimed in claim 1, wherein the deflector has a conical or frusto-conical outer shape.

3. A sensor as claimed in claim 1, wherein the base area of the deflector is at least half the base area of the vessel.

4. A sensor as claimed in claim 1, wherein the deflector extends at least half way up the vessel.

5. A sensor as claimed in claim 1, wherein the deflector extends all the way up the vessel.

6. A sensor as claimed in claim 1, wherein the area at the top of the deflector is no more than half the base area of the deflector.

7. A sensor as claimed in claim 1, wherein the capacitor arrangement comprises a series of parallel capacitor electrodes around the vessel each extending in the direction of the vessel height, with sets of electrodes connected together such that there are two capacitor terminals.

8. A sensor as claimed in claim 7, wherein the series of parallel capacitor electrodes are copper tracks provided on a flexible printed circuit board which is wrapped around the vessel.

9. A sensor as claimed in claim 1 further comprising a second vessel in fluid communication with the vessel, for detecting a permittivity of the liquid.

10. A sensor as claimed in claim 9, wherein the second vessel comprises a cylinder located beneath the vessel.

11. A sensor as claimed in claim 10, wherein the second vessel cylinder has an internal diameter in the range 1 mm to 5 mm.

12. A sensor as claimed in claim 9 comprising a capacitor electrode arrangement around the second vessel.

13. A sensor as claimed in claim 1 wherein the vessel comprises a cylinder with an internal diameter in the range 10 mm to 20 mm and a height in the range 10 mm to 40 mm, wherein the deflector comprises a cone with base diameter in the range 75% to 100% of the internal cylinder diameter or a frusto-cone with base diameter in the range 75% to 100% of the internal cylinder diameter and a top diameter less than 60% of the internal cylinder diameter.

14. A sensor as claimed in claim 13, wherein the deflector comprises a frusto-cone and the top diameter is in the range 30% to 60% of the internal cylinder diameter.
